(19) United States
(12) Patent Application Publication
(10) Pub. No.: US 2025/0050226 A1
(43) Pub. Date: Feb. 13, 2025

(54) Player Avatar Modification Based on Spectator Feedback

(71) Applicants: Sony Interactive Entertainment Inc., Tokyo (JP); Sony Interactive Entertainment LLC, San Mateo, CA (US)

(72) Inventors: Morgan Escalera, San Mateo, CA (US); Azita Refah, San Mateo, CA (US); Benaisha Patel, San Mateo, CA (US); Steven Osman, San Francisco, CA (US); Natsuho Okada, San Mateo, CA (US)

(21) Appl. No.: 18/799,801

(22) Filed: Aug. 9, 2024

Related U.S. Application Data
(60) Provisional application No. 63/518,826, filed on Aug. 10, 2023.

(51) Int. Cl. A63F 13/69; A63F 13/86; A63F 13/87; G06F 40/279; G06F 40/30

(52) U.S. Cl. CPC A63F 13/69; A63F 13/86; A63F 13/87; G06F 40/279; G06F 40/30; A63F 2300/5553

(57) ABSTRACT

A method for dynamically altering an avatar in a video game is provided, including: streaming gameplay video of a session of a video game over a network to a plurality of spectator devices, wherein the session enables gameplay by a player represented by an avatar in the video game; receiving, over the network from the plurality of spectator devices, comments from spectators viewing the gameplay video via the spectator devices; analyzing the comments to determine content of the comments during the session; using the determined content of the comments to generate an avatar modification for the player; implementing the avatar modification to alter the avatar of the player.

### CLAIM OF PRIORITY

The present patent application claims the benefit of and priority, under 35 USC § 119(e), to U.S. provisional patent application No. 63/518,826, filed on Aug. 10, 2023, and titled “PLAYER AVATAR MODIFICATION BASED ON SPECTATOR FEEDBACK”, which is incorporated by reference herein in its entirety.

### BACKGROUND OF THE INVENTION

The video game industry has seen many changes over the years. As technology advances, video games continue to achieve greater immersion through sophisticated graphics, realistic sounds, engaging soundtracks, haptics, etc. Players are able to enjoy immersive gaming experiences in which they participate and engage in virtual environments, and new ways of interaction are sought. Furthermore, players may stream video of their gameplay for spectating by spectators, enabling others to share in the gameplay experience.

However, while spectators may view a given player's gameplay, they do not interact in a way that directly impacts the gameplay of the player.

It is in this context that implementations of the disclosure arise.

### SUMMARY OF THE INVENTION

Implementations of the present disclosure include methods, systems and devices for modifying a player avatar in a video game based on spectator feedback.

In some implementations, a computer-implemented method for dynamically altering an avatar in a video game is provided, including: streaming gameplay video of a session of a video game over a network to a plurality of spectator devices, wherein the session enables gameplay by a player represented by an avatar in the video game; receiving, over the network from the plurality of spectator devices, comments from spectators viewing the gameplay video via the spectator devices; analyzing the comments to determine content of the comments during the session; using the determined content of the comments to generate an avatar modification for the player; implementing the avatar modification to alter the avatar of the player.

In some implementations, analyzing the comments includes identifying keywords from said comments, and further determining a relative importance of said keywords based on the comments.

In some implementations, using the determined content of the comments to generate the avatar modification includes generating an input prompt based on the determined content and applying said input prompt to a generative artificial intelligence (AI) to generate the avatar modification.

In some implementations, implementing the avatar modification occurs during the session.

In some implementations, implementing the avatar modification occurs during a break point in the gameplay.

In some implementations, implementing the avatar modification alters an appearance of at least a portion of the avatar.

In some implementations, implementing the avatar modification is in response to an approval by the player.

In some implementations, the comments include text or emojis.

In some implementations, a computer-implemented method for dynamically altering an avatar in a video game is provided, including: streaming gameplay video of a session of a video game over a network to a plurality of spectator devices, wherein the session enables gameplay by a player represented by an avatar in the video game; receiving, over the network from the plurality of spectator devices, comments from spectators viewing the gameplay video via the spectator devices; analyzing the comments to determine content of the comments during the session; using the determined content of the comments to generate a plurality of avatar modifications for the player; receiving a selection of one of the avatar modifications by the player; responsive to said selection, then implementing the selected avatar modification to alter the avatar of the player.

In some implementations, a computer-implemented method for dynamically altering an avatar in a video game is provided, including: streaming gameplay video of a session of a video game over a network to a plurality of spectator devices, wherein the session enables gameplay by a player represented by a first avatar in the video game; receiving, over the network from the plurality of spectator devices, comments from spectators viewing the gameplay video via the spectator devices; analyzing the comments to determine content of the comments during the session; using the determined content of the comments to generate a second avatar for the player; replacing the first avatar of the player with the second avatar.

Other aspects and advantages of the disclosure will become apparent from the following detailed description, taken in conjunction with the accompanying drawings, illustrating by way of example the principles of the disclosure.

### BRIEF DESCRIPTION OF DRAWINGS

The disclosure may be better understood by reference to the following description taken in conjunction with the accompanying drawings in which:

FIG. 1 conceptually illustrates a system for altering a player avatar based on spectator feedback, in accordance with implementations of the disclosure.

FIG. 2 conceptually illustrates a process for generating avatar modifications based on spectator feedback, in accordance with implementations of the disclosure.

FIG. 3 conceptually illustrates a process incorporating spectator voting for a modification of a player avatar, in accordance with implementations of the disclosure.

FIG. 4 conceptually illustrates a process incorporating player selection of suggested avatar modifications for the player's avatar, in accordance with implementations of the disclosure.

FIG. 5 conceptually illustrates training of a generative artificial intelligence to leverage an asset library of a video game for avatar modification, in accordance with implementations of the disclosure.

FIG. 6 illustrates components of an example device 600 that can be used to perform aspects of the various embodiments of the present disclosure.

### DETAILED DESCRIPTION OF THE INVENTION

Broadly speaking, implementations of the present disclosure provide systems and methods for altering a player's avatar in a video game based on spectator feedback. For example, comments made by the spectators during the player's gameplay can be analyzed to determine their contents and sentiment. This can be used to effect changes to the avatar of the player. In some implementations, the sentiment of the comments is used to generate an input prompt that is fed to a generative artificial intelligence (AI), which generates one or more suggested modifications to the player's avatar.

In order to prevent the player from being subjected to avatar changes that they do not approve of, in some implementations, the player has the option to decline a suggested modification to their avatar. In some implementations, spectators may vote from a plurality of suggested avatar modifications. In other implementations, the player may choose from a plurality of suggested avatar modifications. It will be appreciated that modification of the player avatar can include modification of a portion of the avatar, such as changing the appearance of a part, or changing the entirety of the player avatar, effectively switching the player's avatar from one avatar to another.

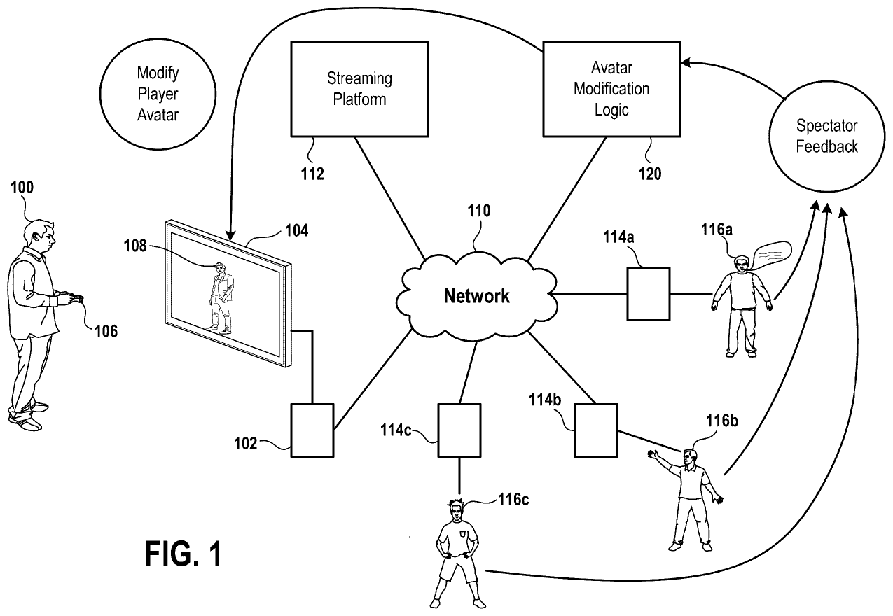

FIG. 1 conceptually illustrates a system for altering a player avatar based on spectator feedback, in accordance with implementations of the disclosure.

In the illustrated implementation, a player 100 engages in gameplay of a video game. For example, a session of the video game may be executed by a player device 102 (such as a game console, personal computer, mobile device, etc.) and the gameplay video generated by the executing video game is presented on a display 104. In some implementations, the display 104 is integrated with the player device 102. The player 100 may provide input to the video game using a controller device 106, which can be a game controller, keyboard, mouse, joystick, touchpad, or other input device capable of being used for gameplay. In alternative implementations, the video game can be cloud-executed, such that the session is executed by a cloud resource, with gameplay video streamed over network 110 (e.g. including the Internet) to the player device 102 for presentation on the display 104.

As the player 100 engages in gameplay of the video game, the gameplay video (including audio) can also be shared over network 110 for viewing by a plurality of spectators 116a, 116b, and 116c. The gameplay video can be shared in substantial or near real time, so that the player 100 is live streaming their gameplay to the spectators for viewing. More specifically, in some implementations, the gameplay video is first transmitted over network 110 to a streaming platform 112, which handles distribution of the gameplay video over network 110 to various spectator devices 114a, 114b, and, 114c, which present the gameplay video on respective displays (not shown) for viewing by the spectators 116.

In the context of the video game, the player 100 is represented by an avatar 108, as conceptually shown in the illustrated implementation. By way of example without limitation, the avatar 108 can be a character (e.g. person, animal, creature, robot, etc.) or any other object, being, or entity (e.g. vehicle, building, city, etc.) that may represent the player 100 in the video game, or that the player controls for purposes of gameplay of the video game. In some instances, the player 100 controls not just a single entity, but a plurality of entities, such as in a team sports game, where the player 100 may control a team of players in the game. For purposes of the present disclosure, the term “avatar” as used herein should be understood as also encompassing a team or other group of entities that represent the player 100 in the video game. Generally speaking, the avatar's actions in the video game are controllable by the player 100, such as via input commands provided through controller device 106.

In some implementations, the player 100 not only streams their gameplay video, but also a live video feed of themself as they play the game. This enables the player 102 to share their appearance, showing their reactions during gameplay, and also talk to their spectators in real-time as they play the game.

As the spectators 116 spectate the gameplay, they may react to the gameplay through various mechanisms. For example, the spectators may provide written comments which are displayed in a comments stream for both the player 100 and the spectators to see. In some implementations, a comments interface for entering/viewing comments and associated functionality are supported by the streaming platform 112. In some implementations, video and/or audio of the spectators can be captured, showing the reactions of the spectators to the gameplay. In accordance with implementation of the disclosure, these and other forms of spectator feedback to the gameplay can be used to effect modifications or changes to the player's avatar. In this manner, the spectators are enabled to affect the appearance of the player's avatar during the session of the video game.

More specifically, in some implementations, avatar modification logic 120 is provided to analyze the spectator feedback and suggest and implement changes to the player avatar 108 based on the spectator feedback. Broadly speaking, the avatar modification logic 120 is configured to determine the content and meaning of the spectator feedback and generate an avatar modification based on this information. The avatar modification logic 120 additionally handles how and when to implement avatar changes. In some implementations, the avatar modification logic 120 is partly or wholly integrated with the streaming platform 112.

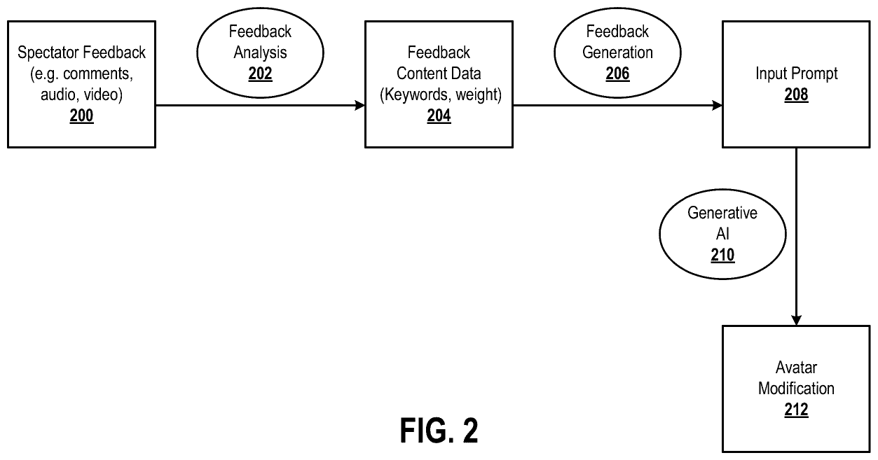

FIG. 2 conceptually illustrates a process for generating avatar modifications based on spectator feedback, in accordance with implementations of the disclosure.

The illustrated process can be implemented by the avatar modification logic 120. In the illustrated implementation, spectator feedback 200 can include various forms of spectator reactions to gameplay, such as comments (e.g. text, emojis, reactions such as thumbs up/down, etc.), video, and audio of the spectators, as discussed previously. A feedback analysis process 202 is performed on the spectator feedback to determine the contents, meaning and sentiment of the spectator feedback 200. In some implementations, the feedback analysis process 202 can apply a natural language processing (NLP) method and/or a semantic analysis process and/or a sentiment analysis process to any of the spectator feedback 200 to generate feedback content data 204 that reflects the meaning and sentiment of the spectator feedback 200.

For example, in some implementations, an NLP process can be performed on the comments provided by the spectators to understand their meaning. And further sentiment analysis can be performed on the video/audio of the spectators as well as non-language content of the comments (e.g. emojis and reactions), in order to better understand the sentiment of the spectators.

The result of performing the feedback analysis process 202 is the feedback content data 204, which can define a summary of the spectator feedback 200 reflecting its meaning and sentiment. It will be appreciated that the feedback analysis process 202 can include filtering so that no single spectator's feedback is over-represented relative to the totality of the spectators in the feedback content data 204. This filtering can prevent abuse of the system, so that a spectator that expresses a certain thought or emotion cannot unfairly gain additional representation of that thought or emotion in the feedback content data 204, such as by repeatedly expressing the same or a similar thought or emotion.

In some implementations, the feedback content data 204 defines various keywords or phrases, and may further define a level of emphasis/importance or weighting for such keywords or phrases, which can be based in part on the amount or frequency of occurrence of such keywords or phrases in the spectator feedback 200. In some implementations, the feedback content data 204 can be visually conceptualized as a word cloud, in which words or phrases are depicted with their size indicating their relative importance.

A prompt generation process 206 is applied that uses the feedback content data 204 to generate an input prompt 208 for a generative artificial intelligence (AI) 210, which generates one or more suggested avatar modifications 212 based on the input prompt 208. In some implementations, the prompt generation process 206 is configured to structure the input prompt by selecting and ordering keywords from the feedback content data 204 into the input prompt 208 based on their relative importance. In some implementations, the prompt generation process 206 transforms or maps keywords or phrases into word structures or syntax that are compatible with the generative AI 210. For example, a word “strong” with a high level of emphasis in the feedback content data 204 might be transformed into “very strong” or “extremely strong” for purposes of the input prompt 208.

Additionally, in some implementations, the prompt generation process 206 is configured to structure the input prompt 208 to include relevant information relating to the avatar that is to be modified. By way of example without limitation, such may include information about the video game, the relevant art style, the current state of the avatar or any portion thereof, etc. In some implementations, such information can be in the form of graphical data such as a mesh or texture of the avatar or any portion thereof, for example.

As noted, the generative AI 210 generates one or more avatar modifications 212. A given avatar modification can define a change in any portion or the entirety of the player's avatar. In some implementations, a given avatar modification is defined in the form of graphical data such as a texture or image data that can be applied to alter the player's avatar. In some implementations, a given avatar modification is configured to reference an asset of the video game, which can be part of an asset library as discussed in further detail below.

In various implementations, the process for creating an AI-generated avatar modification can be implemented at various points in the video game. For example, in some implementations, the process is performed at break points in the video game, such as at the conclusion of a section, level, achievement, or some predefined portion of the video game's campaign. In some implementations, the process is performed when changing from one scene to another, or moving from one region to another region within a virtual environment of the video game. In some implementations, the process is performed at predefined time intervals. In some implementations, comments or other feedback activity by the spectators is monitored and the process is performed when sufficient activity is detected (e.g. an amount of comments/activity, or frequency of comments/activity, etc.).

In some implementations, the process is performed in part based on gameplay activity occurring in the video game. For example, in some implementations, the process is performed when activity levels in the video game are low, so as not to disturb the player during times of higher activity when the player is engaged in more intense gameplay and may not wish to be distracted by potential changes in their avatar.

In some implementations, when a suggested avatar modification is available, an interface can be presented to the player through which an avatar modification is proposed to the player as a suggested modification, which the player may then approve or disapprove. A preview of the suggested modification can be provided to the player through the interface. In some implementations, a notification is provided to the player when the suggested avatar modification is available, which the player may activate/accept to bring up the interface and view the proposed avatar modification. In this manner, the player can be notified of a possible avatar modification during gameplay with minimal intrusion. In some implementations, when the interface is presented, the gameplay is automatically paused.

In other implementations, an avatar modification can be automatically implemented to change the player's avatar. In some implementations, this can be in accordance with a predefined setting of the player that is configured to allow such modifications to automatically occur during gameplay.

In still other implementations, the avatar modification is proposed to the player in between sessions of the video game, or at the conclusion of a session of the video game, or at the start of a successive session. Thus, the player avatar may be altered in the succeeding session based on spectator activity from the prior session.

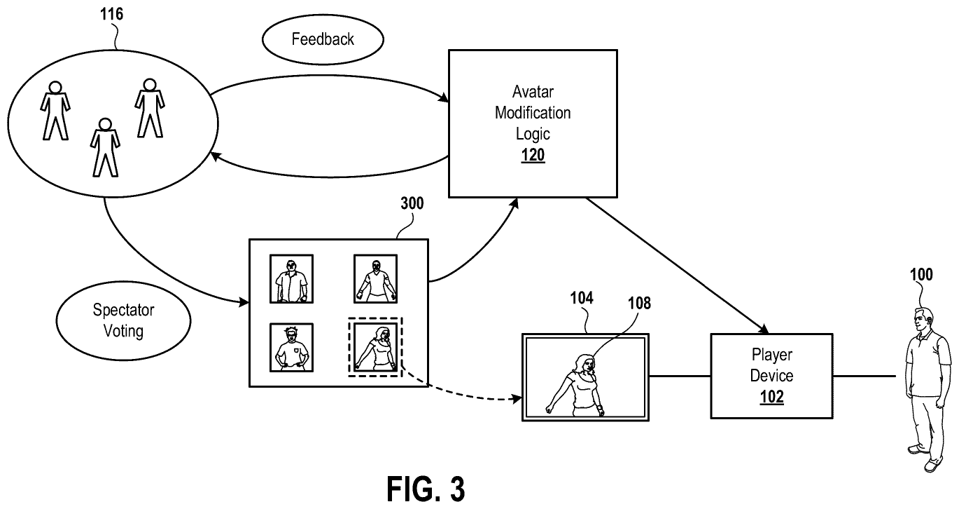

FIG. 3 conceptually illustrates a process incorporating spectator voting for a modification of a player avatar, in accordance with implementations of the disclosure.

In the illustrated implementation, the spectators 116 provide feedback, which is analyzed and used to prompt a generative AI to generate multiple proposed avatar modifications 300, as discussed herein. In some implementations, the spectators vote to determine which of the avatar modifications 300 to implement. For example, when the avatar modifications 300 are generated, then a voting interface can be rendered to the spectators (via their respective spectator devices), enabling the spectators to vote for their favorite one of the avatar modifications. In the event of a tie, there can be a run-off vote. In some implementations, the spectators are asked to rank the avatar modifications in order of their preference, and a ranked choice voting system is employed. The winning one of the avatar modifications can be presented to the player 100 (e.g. through an interface rendered by the player device 102) for approval or implemented directly in some implementations, so as to alter the player avatar 108.

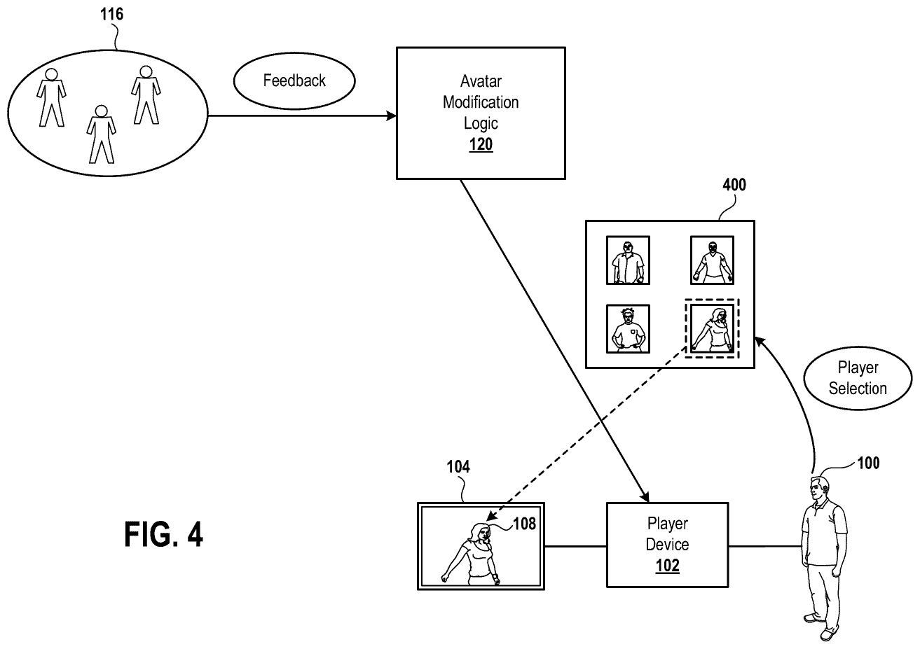

FIG. 4 conceptually illustrates a process incorporating player selection of suggested avatar modifications for the player's avatar, in accordance with implementations of the disclosure.

In the illustrated implementation, the spectators 116 provide feedback, which is analyzed and used to prompt a generative AI to generate multiple suggested avatar modifications 400, as discussed herein. In some implementations, the player 100 is given the option to select one of the suggested avatar modifications 400 to implement. For example, an interface can be presented by the player device 102 on the display 104, showing previews of the suggested avatar modifications 400. The player 100 can select one of the avatar modifications 400 to implement, whereupon the player avatar 108 will be updated to include the selected modification. In this manner, the player 100 is able to see multiple possibilities for avatar modification which are based on the spectators' reactions and feedback during gameplay.

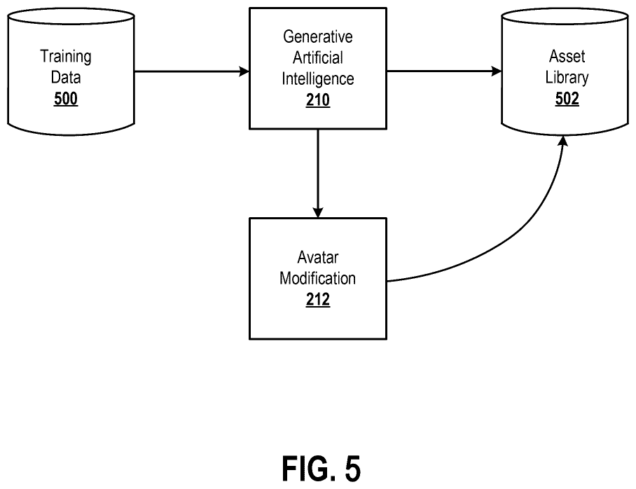

FIG. 5 conceptually illustrates training of a generative artificial intelligence to leverage an asset library of a video game for avatar modification, in accordance with implementations of the disclosure.

As has been discussed, a generative AI 210 is configured to generate an avatar modification 212 based on an input prompt. To accomplish this, the generative AI 210 is first trained using training data 500. In some implementations, the training data 500 maps input data (e.g. words, phrases, imagery, or any other type of data that may be included in an input prompt for the generative AI 210) to components or assets of the asset library 502, so that the generative AI 210 learns associations between the input data and the components or assets of the asset library 502.

In some implementations, the generative AI 210 is trained on the asset library 502 so as to learn the style and functional characteristics of the assets in the asset library 502, so as to be able to generate objects which are consistent with the style and function of the assets of the video game. In some implementations, through training on the asset library 502, the generative AI 210 infers constraints for the generation of avatar modifications.

Then when the generative AI 210 generates an avatar modification 212, the avatar modification 212 can reference the asset library 502, and more specifically reference a particular asset or portion thereof. For example, in some implementations, an avatar modification 212 may be in the form of a generated portion of an asset (e.g. a generated texture for a part of an existing asset). In some implementations, an avatar modification 212 can be in the form of an identification or selection of a specific asset from the asset library 502.

In some implementations, the generative AI 210 is trained to utilize an avatar/character creator 504 that is part of, or configured for use with, the video game. That is, the generative AI 210 is trained to access the logic of the avatar creator 504 to customize the player avatar based on the spectator feedback as presently described. Hence the avatar modification 212 can be in the form of data describing adjustments to settings for the player's avatar which are effected through the avatar creator 504. In some implementations, this entails accessing an application programming interface (API) of the avatar creator 504. It will be appreciated that the avatar creator 504 may access the aforementioned asset library 502 to retrieve and modify avatar-related assets.

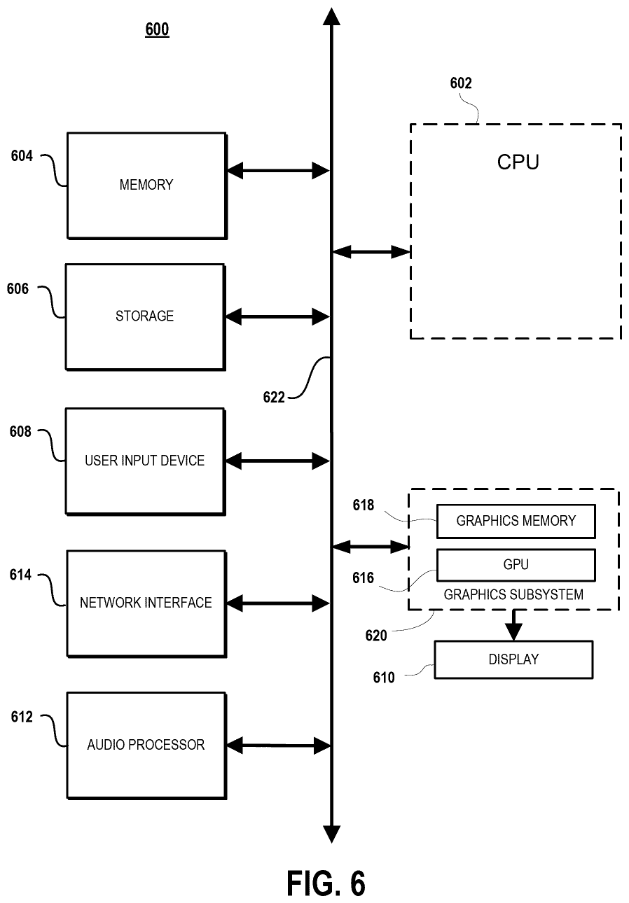

FIG. 6 illustrates components of an example device 600 that can be used to perform aspects of the various embodiments of the present disclosure. This block diagram illustrates a device 600 that can incorporate or can be a personal computer, video game console, personal digital assistant, a server or other digital device, suitable for practicing an embodiment of the disclosure. Device 600 includes a central processing unit (CPU) 602 for running software applications and optionally an operating system. CPU 602 may be comprised of one or more homogeneous or heterogeneous processing cores. For example, CPU 602 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 600 may be a localized to a player playing a game segment (e.g., game console), or remote from the player (e.g., back-end server processor), or one of many servers using virtualization in a game cloud system for remote streaming of gameplay to clients.

Memory 604 stores applications and data for use by the CPU 602. Storage 606 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 608 communicate user inputs from one or more users to device 600, examples of which may include keyboards, mice, joysticks, touch pads, touch screens, still or video recorders/cameras, tracking devices for recognizing gestures, and/or microphones. Network interface 614 allows device 600 to communicate with other computer systems via an electronic communications network, and may include wired or wireless communication over local area networks and wide area networks such as the internet. An audio processor 612 is adapted to generate analog or digital audio output from instructions and/or data provided by the CPU 602, memory 604, and/or storage 606. The components of device 600, including CPU 602, memory 604, data storage 606, user input devices 608, network interface 610, and audio processor 612 are connected via one or more data buses 622.

A graphics subsystem 620 is further connected with data bus 622 and the components of the device 600. The graphics subsystem 620 includes a graphics processing unit (GPU) 616 and graphics memory 618. Graphics memory 618 includes a display memory (e.g., a frame buffer) used for storing pixel data for each pixel of an output image. Graphics memory 618 can be integrated in the same device as GPU 608, connected as a separate device with GPU 616, and/or implemented within memory 604. Pixel data can be provided to graphics memory 618 directly from the CPU 602. Alternatively, CPU 602 provides the GPU 616 with data and/or instructions defining the desired output images, from which the GPU 616 generates the pixel data of one or more output images. The data and/or instructions defining the desired output images can be stored in memory 604 and/or graphics memory 618. In an embodiment, the GPU 616 includes 3D rendering capabilities for generating pixel data for output images from instructions and data defining the geometry, lighting, shading, texturing, motion, and/or camera parameters for a scene. The GPU 616 can further include one or more programmable execution units capable of executing shader programs.

The graphics subsystem 614 periodically outputs pixel data for an image from graphics memory 618 to be displayed on display device 610. Display device 610 can be any device capable of displaying visual information in response to a signal from the device 600, including CRT, LCD, plasma, and OLED displays. Device 600 can provide the display device 610 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A computer-implemented method for dynamically altering an avatar in a video game, comprising:
streaming gameplay video of a session of a video game over a network to a plurality of spectator devices, wherein the session enables gameplay by a player represented by an avatar in the video game;
receiving, over the network from the plurality of spectator devices, comments from spectators viewing the gameplay video via the spectator devices;
analyzing the comments to determine content of the comments during the session;
using the determined content of the comments to generate an avatar modification for the player;
implementing the avatar modification to alter the avatar of the player.

2. The computer-implemented method of claim 1, wherein analyzing the comments includes identifying keywords from said comments, and further determining a relative importance of said keywords based on the comments.

3. The computer-implemented method of claim 1, wherein using the determined content of the comments to generate the avatar modification includes generating an input prompt based on the determined content and applying said input prompt to a generative artificial intelligence (AI) to generate the avatar modification.

4. The computer-implemented method of claim 1, wherein implementing the avatar modification occurs during the session.

5. The computer-implemented method of claim 1, wherein implementing the avatar modification occurs during a break point in the gameplay.

6. The computer-implemented method of claim 1, wherein implementing the avatar modification alters an appearance of at least a portion of the avatar.

7. The computer-implemented method of claim 1, wherein implementing the avatar modification is in response to an approval by the player.

8. The computer-implemented method of claim 1, wherein the comments include text or emojis.

9. A computer-implemented method for dynamically altering an avatar in a video game, comprising:
streaming gameplay video of a session of a video game over a network to a plurality of spectator devices, wherein the session enables gameplay by a player represented by an avatar in the video game;
receiving, over the network from the plurality of spectator devices, comments from spectators viewing the gameplay video via the spectator devices;
analyzing the comments to determine content of the comments during the session;
using the determined content of the comments to generate a plurality of avatar modifications for the player;
receiving a selection of one of the avatar modifications by the player;
responsive to said selection, then implementing the selected avatar modification to alter the avatar of the player.

10. The computer-implemented method of claim 9, wherein analyzing the comments includes identifying keywords from said comments, and further determining a relative importance of said keywords based on the comments.

11. The computer-implemented method of claim 9, wherein using the determined content of the comments to generate the avatar modification includes generating an input prompt based on the determined content and applying said input prompt to a generative artificial intelligence (AI) to generate the avatar modification.

12. The computer-implemented method of claim 9, wherein implementing the avatar modification occurs during the session.

13. The computer-implemented method of claim 9, wherein implementing the avatar modification occurs during a break point in the gameplay.

14. The computer-implemented method of claim 9, wherein implementing the avatar modification alters an appearance of at least a portion of the avatar.

15. A computer-implemented method for dynamically altering an avatar in a video game, comprising:
streaming gameplay video of a session of a video game over a network to a plurality of spectator devices, wherein the session enables gameplay by a player represented by a first avatar in the video game;
receiving, over the network from the plurality of spectator devices, comments from spectators viewing the gameplay video via the spectator devices;
analyzing the comments to determine content of the comments during the session;
using the determined content of the comments to generate a second avatar for the player;
replacing the first avatar of the player with the second avatar.

16. The computer-implemented method of claim 15, wherein analyzing the comments includes identifying keywords from said comments, and further determining a relative importance of said keywords based on the comments.

17. The computer-implemented method of claim 15, wherein using the determined content of the comments to generate the second avatar includes generating an input prompt based on the determined content and applying said input prompt to a generative artificial intelligence (AI) to generate the second avatar.

18. The computer-implemented method of claim 15, wherein replacing the first avatar with the second avatar occurs during the session.

19. The computer-implemented method of claim 15, wherein replacing the first avatar with the second avatar occurs during a break point in the gameplay.
